(19) United States
(12) Patent Application Publication
(10) Pub. No.: US 2024/0059229 A1
(43) Pub. Date: Feb. 22, 2024

(54) IN-VEHICLE COMMUNICATION SUPPORT DEVICE AND IN-VEHICLE COMMUNICATION SUPPORT METHOD

(71) Applicant: ALPS ALPINE CO., LTD., Tokyo (JP)

(72) Inventors: Hiroki TAGAMI, Tokyo (JP); Yuta MORI, Tokyo (JP); Takashi ICHIKAWA, Tokyo (JP)

(73) Assignee: ALPS ALPINE CO., LTD., Tokyo (JP)

(21) Appl. No.: 18/224,681

(22) Filed: Jul. 21, 2023

(30) Foreign Application Priority Data
Aug. 5, 2022 (JP) 2022-125444

(51) Int. Cl. B60R 11/02; B60R 11/04; G06F 3/16

(52) U.S. Cl. CPC B60R 11/0247; B60R 11/04; G06F 3/16

(57) ABSTRACT

One form of an in-vehicle communication support device has: a speech recognition unit configured to recognize a speech by a first occupant according to input information from at least one of a camera or a microphone attached in the vehicle; a target position identification unit configured to identify the sitting position of a second occupant, who is a target for the speech by the first occupant; and a notification unit configured to notify the identified second occupant that a speech has been made for the second occupant. When the first occupant speaks to the second occupant, only the second occupant, who is the target for the speech, is notified. Thus, an occupant notices that the occupant is being spoken to, without occupants irrelevant to the conversation being unnecessarily notified.

### RELATED APPLICATION

The present application claims priority to Japanese Patent Application Number 2022-125444, filed Aug. 5, 2022, the entirety of which is hereby incorporated by reference.

### BACKGROUND

### 1. Field of the Disclosure

The present disclosure relates to an in-vehicle communication support device and an in-vehicle communication support method, and more particularly to a device and a method that support smooth communication between occupants.

### 2. Description of the Related Art

In a conversation between an occupant and another occupant in a vehicle, it may difficult to hear the voice of the other occupant due to loud noises, reproduced audio sound, or the like. When the interest of an occupant spoken by another occupant is directed to an irrelevant thing, the occupant may fail to notice that the occupant is being spoken to by the other occupant. In view of this, a technology is known in which an actuator that generates vibration is attached to the backrest of a back seat so that when an occupant on a front seat starts a speech, the actuator vibrates and another occupant sitting on the back seat is thereby notified of the start of the speech. This reduces the risk that the other occupant fails to hear the beginning of a conversation (see JP 2021-39652 A, for example).

However, the technology described in JP 2021-39652 A has been problematic in that vibration occurs on all back seats, so other occupants who are not spoken to are also notified due to vibration. This is cumbersome to occupants irrelevant to the conversation.

Recently, research and development is actively underway on autonomous cars. Automation levels are set for autonomous cars from level 1, at which a system supports any one of acceleration, steering, and braking, to level 5, at which it is possible to have a system take charge of all driving tasks in all situations, that is, complete autonomous driving is possible. As automation levels progress, behavior styles of occupants in a vehicle may change.

For example, the driver may have much more free time, during which the driver is not busy driving, and may thereby have more opportunities to participate in conversations not only between the left and right seats but also between the front seat and a back seat. The freedom of adjusting the seat layout may also be increased, in which case occupants may have more opportunities to participate in conversations or taking any other behaviors in various postures or attitudes such as a face-to-face style or lying style. In this type of in-vehicle environment, different from previous environments, in an autonomous car, it is predicted that when an occupant is spoken to by another occupant while the occupant is in conversation with yet another occupant or is taking a unique action, the occupant more often fails to notice that the occupant is being spoken by the yet other person.

### SUMMARY

The present disclosure addresses problems such as those described above with the objective of facilitating smooth communications in a vehicle by having an occupant surely notice that the occupant is being spoken to by another occupant, without occupants irrelevant to the conversation being unnecessarily notified.

To address the above problem, in some implementations of the present disclosure, a speech by a first occupant is recognized according to input information from at least one of an imaging means or a sound collecting means, which are attached in a vehicle, the sitting position of a second occupant, who is a target for the speech by the first occupant, is identified, and the identified second occupant is notified that a speech has been given.

According to forms of the present disclosure structured as described above, when a first occupant speaks to a second occupant, only the second occupant, who is a target for the speech, is notified. Thus, it is possible to have an occupant surely notice that the occupant is being spoken to, without occupants irrelevant to the conversation being unnecessarily notified, so smooth communication is possible in the vehicle.

### BRIEF DESCRIPTION OF THE DRAWINGS

FIG. 1 is a block diagram illustrating an example of the functional structure of an in-vehicle communication support device;

FIGS. 2A and 2B illustrate examples in which cameras and microphones used in an in-vehicle communication support system are attached;

FIGS. 3A and 3B illustrate examples in which vibration elements used in the in-vehicle communication support system are attached to seats;

FIGS. 4A and 4B illustrates an example of the operation of the in-vehicle communication support device operates;

FIG. 5 is a flowchart illustrating an example of the operation of the in-vehicle communication support device; and

FIG. 6 illustrates another example in which vibration elements are attached to seats.

### DETAILED DESCRIPTION

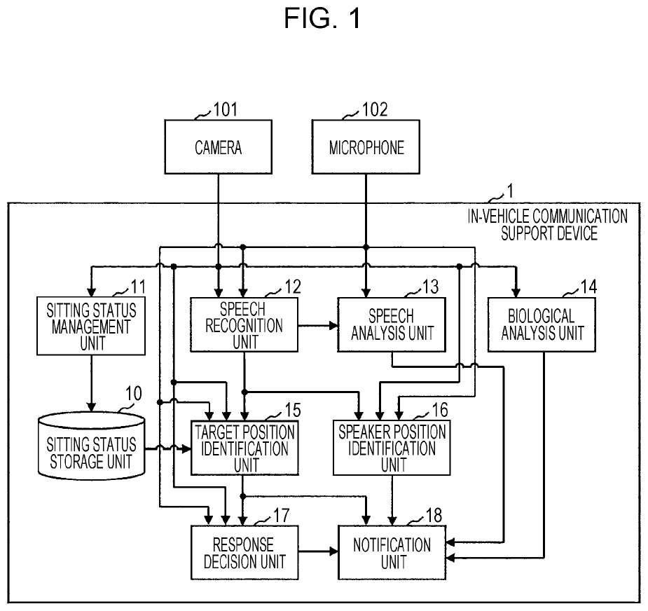

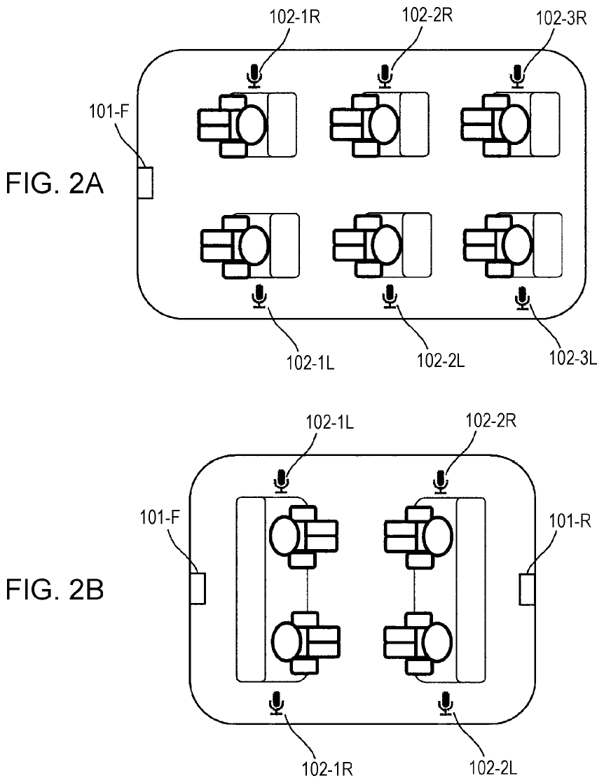

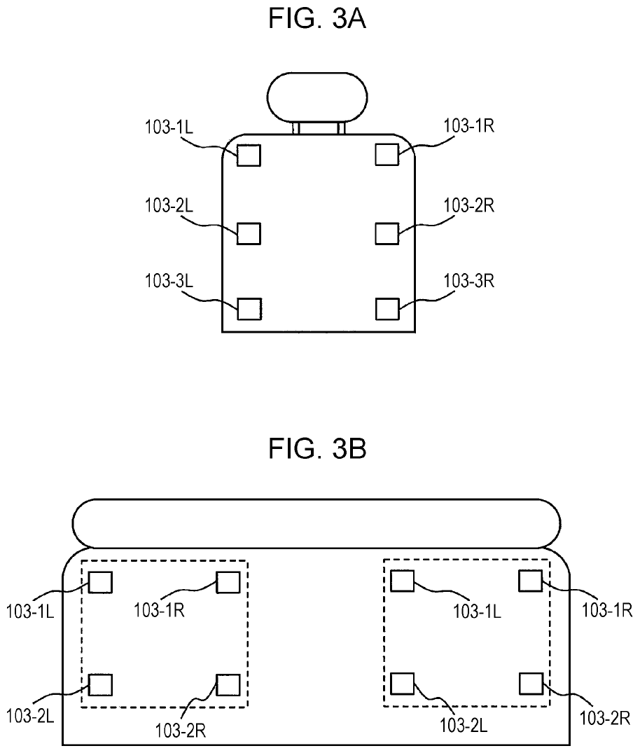

FIG. 1 is a block diagram illustrating an example of a functional structure of an in-vehicle communication support device 1. FIGS. 2A and 2B illustrate examples in which cameras (imaging means) and microphones (sound collecting means) are used in an in-vehicle communication support system, in which the in-vehicle communication support device 1 is applied, are attached. FIGS. 3A and 3B illustrate examples in which vibration elements (tactile stimulus applying means) used in the in-vehicle communication support system are attached to seats.

First, an example in which cameras and microphones are attached will be described with reference to FIGS. 2A and 2B. FIG. 2A illustrates a seat layout in a vehicle having three rows of seats. In this vehicle, two seats are provided, one on the left side and one on the right side, in each of a first row, a second row, and a third row, which are arranged in that order from the front, as illustrated in FIG. 2A. In the vehicle having this type of seat layout, the in-vehicle communication support system in this implementation has a front camera 101-F attached at the front, as well as microphones 102-1R, 102-2R, 102-3R, 102-1L, 102-2L, and 102-3L, each of which is placed in the vicinity of the relevant seat.

FIG. 2B illustrates an example of a seat layout in a vehicle having two rows of seat. In this vehicle, one long seat is provided for each of a first row and a second row, as illustrated in FIG. 2B. This vehicle is an autonomous car, in which the seat in each row is rotatable, so occupants in the first row and occupants in the second row can seat in a face-to-face manner. In a vehicle having this type of seat layout, the in-vehicle communication support system in this implementation has the front camera 101-F attached at the front and a rear camera 101-R attached at the rear, as well as microphones 102-1R, 102-2R, 102-1L, and 102-2L, each of which is placed in the vicinity of the left side or right side of the relevant seat.

In the description below, when the front camera 101-F and rear camera 101-R do not need to be distinguished, they will be simply referred to as cameras 101. Similarly, when the microphones 102-1R, 102-2R, 102-3R, 102-1L, 102-2L, and 102-3L do not need to be distinguished, they will be simply referred to as microphones 102. The camera 101 is attached at a position at which it can take a picture of the entire interior of the vehicle. Therefore, the camera 101 takes a picture in a range in which occupants sitting on all seats are included. In the structure in FIG. 2A, a picture of all occupants is taken with a single camera 101. In the structure in FIG. 2B, a picture of all occupants is taken with two cameras 101. However, this is not a limitation. For example, a plurality of cameras may be attached so that a picture is taken for each row or for each seat.

The microphone 102, which is attached in the vicinity of each seat, collects spoken voice of the occupant setting on the seat. The position of the microphone 102 from which the voice has been collected is confirmed, so the position at which the speech is in progress can be identified. In the collection of spoken voice from occupants sitting on all seats, microphones, the directivity of which can be changed, may be used so that a fewer number of microphones than the number of seats is used. In this case as well, the direction in which the voice has been collected is identified, so the position at which the speech is in progress can be identified.

Next, examples in which vibration elements are attached to seats will be described with reference to FIGS. 3A and 3B. In FIGS. 3A and 3B, the backrest of each seat is viewed from the rear surface. FIG. 3A illustrates an example in which vibration elements are attached to each of the six seats illustrated in FIG. 2A. On the rear surface of the backrest of each seat, a total of six vibration elements denoted 103-1L, 103-1R, 103-2L, 103-2R, 103-3L, and 103-3R are attached on the left side and right side of the upper portion, on the left side and right side of the central portion, and on the left side and right side of the lower portion, as illustrated in FIG. 3A. These six vibration elements 103-1L, 103-1R, 103-2L, 103-2R, 103-3L, and 103-3R correspond to the six seats. The layout of the six vibration elements 103-1L, 103-1R, 103-2L, 103-2R, 103-3L, and 103-3R corresponds to the layout of the six seats on a one-to-one basis. In the description below, when the vibration elements 103-1L, 103-1R, 103-2L, 103-2R, 103-3L, and 103-3R do not need to be distinguished, they will be simply referred to as vibration elements 103.

FIG. 3B illustrates an example in which vibration elements 103 are attached to each of the two seats illustrated in FIG. 2B. In this example, the capacity of one seat is assumed to be two occupants. In the right region (enclosed by dotted lines) of the rear surface of the backrest of each seat, a total of four vibration elements denoted 103-1L, 103-1R, 103-2L, and 103-2R are attached on the left side and right side of the upper portion and on the left side and right side of the lower portion, as illustrated in FIG. 3B. These four vibration elements 103-1L, 103-1R, 103-2L, and 103-2R correspond to the four seats. The layout of the four vibration elements 103-1L, 103-1R, 103-2L, and 103-2R corresponds to the layout of the four seats on a one-to-one basis.

Similarly, in the left region of the rear surface of the backrest of each seat, a total of four vibration elements denoted 103-1L, 103-1R, 103-2L, and 103-2R are attached, as illustrated in FIG. 3B. These four vibration elements 103-1L, 103-1R, 103-2L, and 103-2R correspond to the four seats. The layout of the four vibration elements 103-1L, 103-1R, 103-2L, and 103-2R corresponds to the layout of the four seats on a one-to-one basis.

In this example, it has been assumed that the capacity of one seat is two occupants and a set of four vibration elements 103 is attached in each of the left and right regions of one seat. If the capacity of the seat is three occupants, it is only necessary to attach an additional set of vibration elements 103 in the central region besides the left and right regions; a total of three sets of vibration elements 103 is attached.

Next, the functional structure of the in-vehicle communication support device 1 in this implementation will be described with reference to FIG. 1. As functional blocks, the in-vehicle communication support device 1 has a sitting status management unit 11, a speech recognition unit 12, a speech analysis unit 13, a biological analysis unit 14, a target position identification unit 15, a speaker position identification unit 16, a response decision unit 17, and a notification unit 18, as illustrated in FIG. 1. The in-vehicle communication support device 1 in this implementation also has a sitting status storage unit 10 as a storage medium.

The functional blocks 11 to 18 described above can be implemented by using any of hardware, a digital signal processor (DSP), and software. When, for example, software is used, the above functional blocks 11 to 18 are actually implemented by including a central processing unit (CPU), a random-access memory (RAM), a read-only memory (ROM), and the like. These functional blocks function when programs operate that are stored in the RAM, the ROM, or another storage medium such as a hard disk drive or a semiconductor memory.

The sitting status management unit 11 stores, in the sitting status storage unit 10, sitting status information including occupant information that identifies the occupants in the vehicle and sitting position information that indicates the sitting positions of the occupants in correlation to each other, and manages the sitting status information. The occupant information includes, for example, a user ID, a name, a gender, a relationship in the family (father, mother, elder brother, younger sister, or the like), a nickname, a face image, and the like of each occupant. This occupant information is stored in advance in the sitting status storage unit 10 for each user who is a possible occupant. In contrast, the sitting position information includes information about occupants who are actually in the vehicle. That is, the sitting status management unit 11 recognizes occupants who are actually in the vehicle and their sitting positions by a predetermined method, creates sitting status information including occupant information and sitting position information about the recognized occupants in correlation to each other, and stores the sitting status information in the sitting status storage unit 10.

For example, the sitting status management unit 11 stores face images of users who are possible occupants and occupant information about these users in the sitting status storage unit 10 in advance in correlation to each other. When a user rides the vehicle, a face image captured by the camera 101 is compared with the face images stored in the sitting status storage unit 10 to recognize the user who has ridden on the vehicle. Next, the sitting status management unit 11 analyzes the image captured by the camera 101 to further recognize the seat on which the recognized occupant has sat. The sitting status management unit 11 stores, in the sitting status storage unit 10, the occupant information and sitting position information about the user who has ridden on the vehicle in correlation to each other, according to these recognition results. The sitting status management unit 11 executes this for each user who has ridden on the vehicle

The method of recognizing a user who has ridden on the vehicle as an occupant and also recognizing the sitting position of the occupant is not limited to the example described above. For example, the user may carry a wireless tag or smart phone in which a user ID is stored, and a reader may be attached in the vicinity of each seat. Then, when the user rides the vehicle and sits on a desired seat, the reader attached in the vicinity of the seat may read the user ID from the wireless tag or smart phone of the user so as to recognize the user who has ridden on the vehicle as an occupant and to recognize the sitting position of the occupant. Alternatively, an occupant may operate a touch panel or the like attached on the dashboard or the like to enter information about a user who has ridden on the vehicle and the seat position of the user.

The speech recognition unit 12 recognizes a speech by a first occupant in the vehicle according to input information from at least one of the camera 101 and microphone 102 attached in the vehicle. The first occupant refers to an occupant who has made a speech, the occupant being one of a plurality of occupants sitting status information of whom is stored in the sitting status storage unit 10 by the sitting status management unit 11 and is managed by it. For example, the speech recognition unit 12 analyzes images captured by the camera 101 to recognize an occupant with the mouth open and closed as the first occupant and to recognize that the first occupant is making a speech. Alternatively, the speech recognition unit 12 may identify a microphone 102 into which spoken voice has been entered, the microphone 102 being one of a plurality of microphones 102 attached to seats, one for each seat. Then, the speech recognition unit 12 may recognize the occupant sitting at a position in the vicinity of the identified microphone 102 as the first occupant.

The speech analysis unit 13 analyzes at least one of the content, volume, pitch, and speed of the speech by the first occupant, according to input information from the microphone 102. According to the result of the analysis, the intention of the speech by the first occupant, an emotion during the speech, and the like are inferred.

In the analysis of the content of the speech, the voice data of the spoken voice entered from the microphone 102 is converted to text data (character code), after which a character string indicated by the text data is analyzed. For example, the speech analysis unit 13 uses a known voice recognition technology to convert voice data to text data, after which the speech analysis unit 13 morphologically analyzes a character string indicated by the text data and divides the character string into a plurality of words. Then, the speech analysis unit 13 analyzes the plurality of words to determine whether they include a word that may be used with the intention of strongly attracting the attention of another occupant (such as, for example, a word that may be used during a conversation with urgency or a word that may be used when a speech is made with a strong tone).

In the analysis of the volume, pitch, and speed of the speech, a known acoustic analysis technology can be used. The volume can be obtained by analyzing the sound pressure level of the voice in decibel (dB). The pitch can be obtained by analyzing the frequency of the voice. The speed can be obtained by, for example, measuring a time during which one word is spoken through the analysis of a voice waveform. When at least one of the volume, pitch, and speed of spoken voice is analyzed, it can be inferred whether the first occupant is speaking with the intention of strongly attracting the attention of another occupant and to infer the emotion of the first occupant during the speech, for example. This will be described later in detail.

The biological analysis unit 14 analyzes at least one of a facial expression, the state of the eyes, a blood flow, and a behavior during the speech by the first occupant, according to input information from the camera 101. In this type of analysis as well, the intention of the speech by the first occupant, the emotion of the first occupant during the speech, and the like are inferred. For example, when the facial expression is analyzed, the emotion of the first occupant can be inferred. When the degree of the opening of the pupil or a blood flow rate (or the complexion of the face) is analyzed, it can be inferred whether the first occupant is under excitation. When the head movement and gestures of the first occupant are analyzed, the emotion of the first occupant can be inferred. This will be described later in detail.

The target position identification unit 15 identifies the sitting position of a second occupant, who is a target for the speech by the first occupant recognized by the speech recognition unit 12, according to input information from at least one of the camera 101 and microphone 102. When the vehicle has a seat layout of three rows of seats as illustrated in FIG. 2A, the sitting position of the second occupant is the position of the seat on which the second occupant is sitting. When the vehicle has a seat layout of face-to-face seats as illustrated in FIG. 2B, the sitting position of the second occupant is the right side or left side of the seat on which the second occupant is sitting.

For example, according to input information from the camera 101, the target position identification unit 15 detects at least one of the line of vision and face orientation of the first occupant to identify the sitting position of the second occupant. That is, under the assumption that another occupant for the speech is present in the direction of the line of vision or face orientation of the first occupant, the target position identification unit 15 identifies the sitting position in the direction of the line of vision or the direction of the face orientation as the sitting position of the second occupant.

The target position identification unit 15 also analyzes an occupant involved in the speech by the first occupant, according to input information from the microphone 102. According to the result of the analysis and sitting status information stored in the sitting status storage unit 10, the target position identification unit 15 identifies the sitting position of the second occupant.

For example, the target position identification unit 15 morphologically analyzes a character string indicated by text data resulting from converting voice data of spoken voice entered from the microphone 102, and divides the character string into a plurality of words. Then, the target position identification unit 15 decides whether a word representing an occupant is included in the plurality of words. If an occupant is included, the target position identification unit 15 analyzes the occupant involved in the speech. A word representing an occupant is, for example, the name or nickname of an occupant or a reading according to a relationship in a family (when the relationship is a father, the word is “daddy”, “papa”, or the like). Words of this type are stored in advance in a dictionary database.

If, for example, the first occupant says “Hey papa, . . . ”, the target position identification unit 15 analyzes the occupant involved in the speech as a farther. That is, the target position identification unit 15 analyzes the occupant involved in the speech as the target for the speech and also analyzes who the target is. The target position identification unit 15 further references sitting status information in the sitting status storage unit 10 according to the analysis result and identifies the sitting position of the farther analyzed as the occupant involved in the speech.

If the first occupant says “Hey guys, . . . ”, the target position identification unit 15 decides that all occupants are involved in the speech. Then, the sitting status storage unit 10 references sitting status information in the sitting status storage unit 10 and identifies the sitting positions of all occupants as the sitting position of the second occupant.

Although analysis based on input information from the camera 101 and analysis based on input information from the microphone 102 have been described, only any one of these analyses may be performed. However, it is preferable to perform both analyses. If, for example, a plurality of sitting positions are present in the direction of the line of vision or face orientation of the first occupant, only the analysis of an image captured by the camera 101 is insufficient to identify the sitting position of the second occupant. When input voice from the microphone 102 is also analyzed, however, the sitting position of the second occupant may be identified. Conversely, if a word by which an occupant can be identified is not included in spoken voice, only the analysis of input voice from the microphone 102 is insufficient to identify the sitting position of the second occupant. When an image captured by the camera 101 is also analyzed, however, the sitting position of the second occupant may be identified.

Therefore, it is preferable to perform both the analysis of an image captured by the camera 101 and the analysis of input voice from the microphone 102. Although, for example, the analysis of an image captured by the camera 101 is performed, the sitting position of the second occupant may not be identified, in which case input voice from the microphone 102 may be additionally analyzed. Conversely, although the analysis of input voice from the microphone 102 is performed, the sitting position of the second occupant may not be identified, in which case an image captured by the camera 101 may be additionally analyzed. Although both the analysis of an image captured by the camera 101 and the analysis of input voice from the microphone 102 are performed, the sitting position of the second occupant may not be identified, in which case a plurality of sitting positions inferred from the result of the analysis of an image captured by the camera 101 may be identified as the sitting positions of the second occupant.

When, in a vehicle having a three-row seat layout as illustrated in FIG. 2A, an occupant (first occupant) on the seat in the third row on the right side speaks to another occupant on the right side, for example, there are a seat in the first row and a seat in the second row in the direction of the line of vision or face orientation of the first occupant. Therefore, the seat on which the occupant spoken to is sitting cannot be identified. In this case, if a word by which an occupant can be identified is not included in the speech, even when input voice from the microphone 102 is analyzed, sitting positions of the second occupant cannot be narrowed down to one. Then, the target position identification unit 15 identifies the seat on the first row and the seat on the second row on the right side as the sitting positions of the second occupant.

The speaker position identification unit 16 identifies the sitting position of the first occupant the speech by whom has been identified by the speech recognition unit 12, according to input information from at least one of the camera 101 and microphone 102. For example, the speaker position identification unit 16 analyzes a captured image of the whole interior of the vehicle, the captured image being entered by the camera 101 to identify the sitting position of the first occupant with the mouth open and closed. The speaker position identification unit 16 also identifies, as the sitting position of the first occupant, the position at which the microphone 102 from which the spoken voice has been entered is disposed, the microphone 102 being one of a plurality of microphones 102 attached to seats, one for each seat. Alternatively, when the directivity of the microphone 102 is variable, the speaker position identification unit 16 analyzes spoken voice to identify a direction in which the spoken voice has been entered, and thereby identifies the position at which the speech is in progress as the sitting position of the first occupant.

The response decision unit 17 decides whether the second occupant has responded within a predetermined time after the sitting position of the second occupant was identified by the target position identification unit 15, according to input information from at least one of the camera 101 and microphone 102. For example, the response decision unit 17 detects the direction of the line of vision or face orientation of the second occupant to decide whether the second occupant has taken such a behavior as seeing the first occupant within the predetermined time, according to the image captured by the camera 101. The response decision unit 17 also decides whether the second occupant has responded to the speech by the first occupant within the predetermined time according to input voice from the microphone 102 attached in the vicinity of the sitting position of the second occupant.

The notification unit 18 notifies the second occupant at the sitting position identified by the target position identification unit 15 that a speech has been made for the second occupant. The vibration element 103 attached at the sitting position of the second occupant is operated to notify the second occupant. The notification unit 18 is operated to make this notification only when the response decision unit 17 decides that there is no response from the second occupant within the predetermined time.

The notification unit 18 makes a control to select a portion at which to operate the vibration element 103, according to the sitting position, identified by the speaker position identification unit 16, of the first occupant. That is, the notification unit 18 makes a control so as to operate the vibration element 103 attached at a portion corresponding to the sitting position of the first occupant, the vibration element 103 being one of a plurality of vibration elements 103 attached at the sitting position of the second occupant.

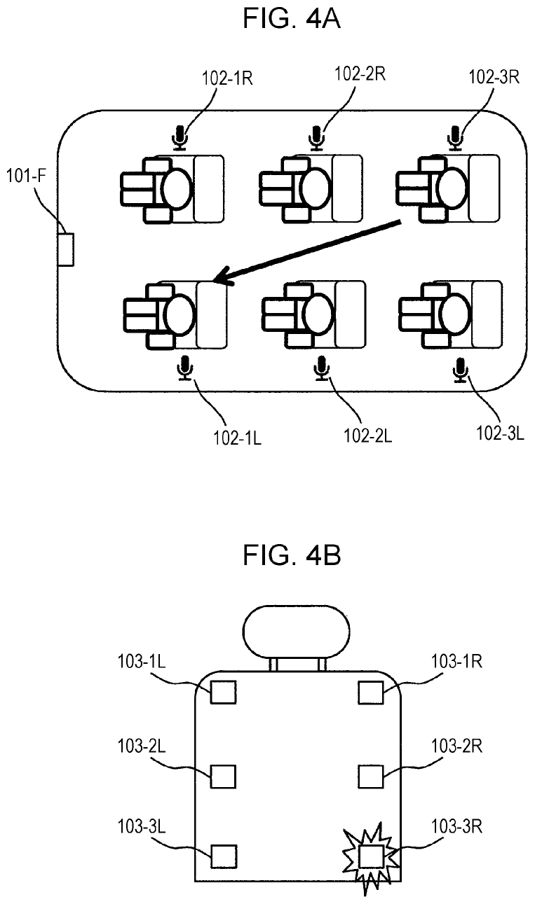

An example will be taken in which, in a vehicle having a three-row seat layout as illustrated in FIG. 4A, for example, an occupant (first occupant) on the seat in the third row on the right side has spoken to another occupant (second occupant) in the first row on the left side. In this case, as illustrated in FIG. 4B, the notification unit 18 makes a control so as to operate a vibration element 103-3R attached at a portion corresponding to the seat of the first occupant, the vibration element 103-3R being one of a plurality of vibration elements 103 attached to the seat of the second occupant. Thus, the second occupant can notice that the second occupant is being spoken to by the first occupant on the third seat on the right side.

The notification unit 18 may vibrate the vibration element 103-3R on and off a plurality of times so that the second occupant feels as if the second occupant were tapped on the body. This can make it easy for the second occupant to recognize that the second occupant is called from the first occupant.

The notification unit 18 also controls a mode of a tactile stimulus (vibration) to be applied by the vibration element 103, according to the result of analysis by the speech analysis unit 13. If, for example, the result of analysis by the speech analysis unit 13 indicates that the spoken voice includes a word that may be used with the intention of strongly attracting the attention of another occupant, the notification unit 18 controls the vibration element 103 so that first vibration, which is in a low-frequency band and is strong, is applied. Otherwise, the notification unit 18 controls the vibration element 103 so that second vibration, which is in a medium-frequency band and is weaker than the first vibration, is applied. The number of applications of the first vibration may be greater than the number of applications of the second vibration. Alternatively, a time during which the first vibration is applied may be longer than a time during which the second vibration is applied.

If the result of analysis by the speech analysis unit 13 indicates that a volume, a pitch, and a speed, the spoken voice, by which it is inferred that the first occupant is speaking with the intention of strongly attracting the attention of another occupant or with high emotion, the notification unit 18 controls the vibration element 103 so that it applies the first vibration. Otherwise, the notification unit 18 controls the vibration element 103 so that it applies the second vibration. For example, the notification unit 18 controls the vibration element 103 so that it applies the first vibration if at least one of the following is satisfied: the volume of the spoken voice is greater than a predetermined threshold; the pitch of the spoken voice is higher than a predetermined threshold, and the speed of the speech is higher than a predetermined threshold.

Although thresholds common to occupants have been used in the above example, this is not a limitation. For example, a volume, a pitch, and a speech speed during a normal speech may be stored in advance as user-specific feature information for each of a plurality of users who are possible occupants. Then, the volume, pitch, and speech speed may be used as individual thresholds for the relevant occupant.

As another example, the notification unit 18 may use a predetermined algorithm to represent the volume, pitch, and speed of spoken voice analyzed by the speech analysis unit 13 as a score. If the score is greater than a threshold, the notification unit 18 may control the vibration element 103 so that it applies the first vibration. If the score is equal to or smaller than the threshold, the notification unit 18 may control the vibration element 103 so that it applies the second vibration. Thresholds used in this example may also be thresholds common to occupants, regardless of occupants. Alternatively, individual thresholds may be used that are set for each user who is a possible user, according to occupant-specific feature information stored in advance for the user.

The notification unit 18 also controls a mode of a tactile stimulus (vibration) to be applied by the vibration element 103, according to the result of analysis by the biological analysis unit 14. Specifically, if the result of analysis by the biological analysis unit 14 indicates a facial expression, the state of the eyes, a blood flow, or a behavior by which it is inferred that the first occupant is speaking with the intention of strongly attracting the attention of another occupant or with high emotion, the notification unit 18 controls the vibration element 103 so that it applies the first vibration. Otherwise, the notification unit 18 controls the vibration element 103 so that it applies the second vibration.

For example, the result of analysis by the biological analysis unit 14 may indicate an expression in which the eyes or mouth is wide-open, an irritated expression, or a startled expression. Then, the notification unit 18 controls the vibration element 103 so that it applies the first vibration. As another example, the result of analysis by the biological analysis unit 14 may indicate a state in which the pupils are wide-open, the face is blushing, or the movement of head or gestures are large. Then, the notification unit 18 controls the vibration element 103 so that it applies the first vibration.

The notification unit 18 may use a predetermined algorithm to represent the expression of the face, the state of the pupils, the blood flow, and the behavior indicated by the result of analysis by the biological analysis unit 14 as a score, for example. If the score is greater than a threshold, the notification unit 18 may control the vibration element 103 so that it applies the first vibration. If the score is equal to or smaller than the threshold, the notification unit 18 may control the vibration element 103 so that it applies the second vibration. In the decision based on the result of analysis by the biological analysis unit 14 as well, a threshold common to occupants may be used, regardless of occupants. Alternatively, individual thresholds may be used that are set for each user who is a possible user, according to occupant-specific feature information stored in advance for the user, as in the decision based on the result of analysis by the speech analysis unit 13.

The result of analysis by the speech analysis unit 13 and the result of analysis by the biological analysis unit 14 may be combined together to represent these results as a score by using a predetermined algorithm. If the score is greater than a threshold, the notification unit 18 may control the vibration element 103 so that it applies the first vibration. If the score is equal to or smaller than the threshold, the notification unit 18 may control the vibration element 103 so that it applies the second vibration. Alternatively, only one of the result of analysis by the speech analysis unit 13 and the result of analysis by the biological analysis unit 14 may be used in the control of the vibration element 103.

In the examples above, any one of two types of vibration, the first vibration and the second vibration, has been applied. However, any one of three or more types of vibration may be applied. In this case, it suffices to set two or more thresholds.

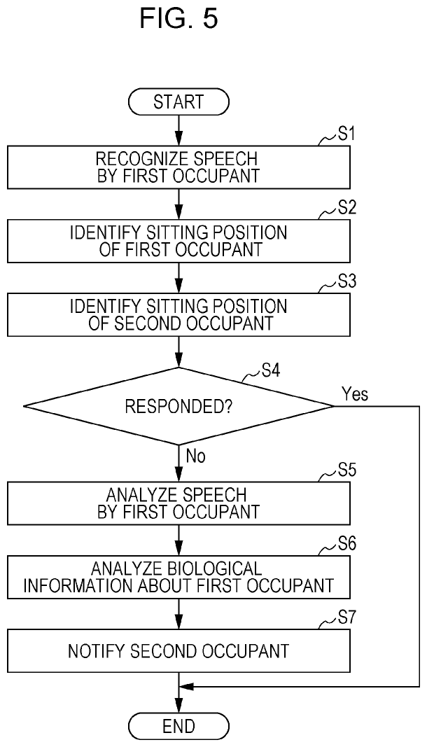

FIG. 5 is a flowchart illustrating an example of the operation of the in-vehicle communication support device 1 that is structured as described above. It will be assumed that sitting status information has been stored in the sitting status storage unit 10 by the sitting status management unit 11.

First, the speech recognition unit 12 recognizes a speech by the first occupant in the vehicle, according to input information from at least one of the camera 101 and microphone 102 attached in the vehicle (step S1). Then, the speaker position identification unit 16 identifies the sitting position of the first occupant, the speech by whom has been recognized by the speech recognition unit 12, according to input information from at least one of the camera 101 and microphone 102 (step S2). The target position identification unit 15 also identifies the sitting position of the second occupant, who is a target for the speech by the first occupant recognized by the speech recognition unit 12, according to input information from at least one of the camera 101 and microphone 102 (step S3). The sequence of steps S2 and S3 may be reversed.

Next, the response decision unit 17 decides whether the second occupant has responded within a predetermined time after the sitting position of the second occupant was identified by the target position identification unit 15, according to input information from at least one of the camera 101 and microphone 102 (step S4). If the second occupant has responded within the predetermined time, one execution of processing in the flowchart in FIG. 5 is completed.

If the second occupant has not responded within the predetermined time, the speech analysis unit 13 analyzes at least one of the content, volume, pitch, and speed of the speech by the first occupant, according to input information from the microphone 102 (step S5). In addition, the biological analysis unit 14 analyzes at least one of facial expression, the state of the eyes, a blood flow, and a behavior during the speech by the first occupant, according to input information from the camera 101 (step S6). The sequence of steps S5 and S6 may be reversed. Processing in steps S5 and S6 may be started while the in-vehicle communication support device 1 waits for the predetermined time to elapse in step S4.

Next, the notification unit 18 operates the vibration element 103 attached at a portion corresponding to the sitting position of the first occupant identified in step S2, the vibration element 103 being one of a plurality of vibration elements 103 attached at the sitting position, identified in step S3, of the second occupant, to notify the second occupant that a speech has been made for the second occupant by the first occupant (step S7). At this time, the notification unit 18 controls the vibration element 103 so that any one of the first vibration and second vibration is applied to the vibration element 103, according the result of analysis performed by the speech analysis unit 13 in step S5 and the result of analysis performed by the biological analysis unit 14 in step S6. This completes one execution of processing in the flowchart in FIG. 5.

Processing in the flowchart in FIG. 5 is repeatedly executed each time the speech recognition unit 12 recognizes a speech by the first occupant in step S1. While processing in steps S1 to S6 is executed because a speech by an occupant is recognized, a speech by another occupant may be recognized by the speech recognition unit 12. Then, processing in steps S1 to S6 in which the occupant is handled as the first occupant and processing in steps S1 to S6 in which the other occupant is handled as the first occupant are concurrently executed.

Processing in step S2 and later may be executed only when a speech by the first occupant is recognized by the speech recognition unit 12 in step S1 after a silent state continues for a predetermined time or more. Alternatively, processing in steps S1 to S3 may be executed each time a speech by an occupant is recognized by the speech recognition unit 12. Then, processing in step S4 and later may be executed only when it is decided that there has been no conversation between two occupants identified in steps S1 and S3 for a predetermined time or more. This can prevent a notification after a conversation starts between the first occupant and the second occupant.

As described above in detail, in this implementation, a speech by the first occupant in the vehicle is recognized, the sitting position of the second occupant, who is a target for the speech by the first occupant, is identified, and the second occupant at the identified sitting position is notified that a speech has been made for the second occupant, according to one of input information from at least one of the camera 101 and microphone 102 attached in the vehicle.

In implementations structured as described above, when the first occupant speaks to the second occupant, only the second occupant, who is a target for the speech by the first occupant, is notified. Thus, the second occupant can notice that the second occupant is being spoken to without occupants irrelevant to the conversation being unnecessarily notified, so smooth communication is possible in the vehicle.

In some implementations, the line of vision or face orientation of the first occupant is detected according to input information from the camera 101 to identify the sitting position of the second occupant, an occupant involved in the speech by the first occupant is analyzed according to input information from the microphone 102, and the sitting position of the second occupant is identified according to the result of the analysis. Although the sitting position of the second occupant may be identified according to only any one of input information from the camera 101 and input information from the microphone 102, when the sitting position of the second occupant is identified according to both pieces of input information, the sitting position of the second occupant can be more reliably identified.

In some implementations, the sitting position of the first occupant is identified according to input information from at least one of the camera 101 and microphone 102, and a vibration element 103 attached at a portion corresponding to the sitting position of the first occupant is operated, the vibration element 103 being one of a plurality of vibration elements 103 attached at the sitting position of the second occupant. This not only can make the second occupant notice that the second occupant is being spoken to, but also can make it easy for the second occupant to recognize the position of an occupant who is speaking to the second occupant, so smooth communication is possible in the vehicle.

Although the sitting position of the first occupant may be identified according to only any one of input information from the camera 101 and input information from the microphone 102, when the sitting position of the first occupant is identified according to both pieces of input information, the sitting position of the first occupant can be more reliably identified.

In some implementations, at least one of the content, volume, pitch, and speed of the speech by the first occupant is analyzed according to input information from the microphone 102, and at least one of a facial expression, the state of the eyes, a blood flow, and a behavior during the speech by the first occupant is analyzed according to input information from the camera 101, after which a mode of vibration to be applied by the vibration element 103 is controlled. Thus, the mode of vibration is changed according to urgency represented in the speech by the first occupant, intention such as a loud call, or emotion during the speech. Therefore, the second occupant can recognize intention of the speech by the first occupant or emotion during the speech by being vibrated.

Although only any one of input information from the camera 101 and input information from the microphone 102 may be analyzed, when both pieces of input information are analyzed, an intention of the speech by the first occupant or emotion during the speech can be more precisely inferred. These analyses and control of the mode of vibration are not a necessity, but when preferably performed, an intuitive conversation closer to a daily conversation can be supported.

In some implementations, it is decided that whether the second occupant has responded within a predetermined time after the sitting position of the second occupant was identified, according to input information from at least one of the camera 101 and microphone 102. A notification is made only when it is decided that the second occupant has not responded within the predetermined time. This can prevent a notification while a conversation is established between the first occupant and the second occupant in a usual manner. Therefore, an extra notification is not made to an occupant who has noticed that the occupant is spoken to by another occupant and has started a conversation in a usual manner, so smooth communication is possible in the vehicle.

In an arrangement in which a notification is made only when a speech by the first occupant is recognize after a silent state continues for a predetermined time or more, the second occupant can be notified only when the second occupant is spoken to by the first occupant for the first time. This can prevent extra notifications after a conversation starts. In an arrangement in which a notification is made only when a speech by the first occupant is recognized between two occupants between whom there has been no conversation for a predetermined time or more, when, for example, the first occupant speaks to a second occupant and then speaks to another second occupant without entering a silent state for a predetermined time or more, a notification can be made at the time of the speech. Thus, more smooth communication is possible in the vehicle without an extra notification being made during a conversation.

In the above-described implementations, an example has been described in which the vibration element 103 (tactile stimulus applying means) is used as a means for making a notification. However, the present disclosure is not limited to this example. For example, a visual stimulus applying means may be used. Alternatively, both a tactile stimulus applying means and a visual stimulus applying means may be used together. In a possible example of a visual stimulus applying means, light is emitted from a light-emitting diode (LED). In another example, a message is displayed on a display device. In these examples, the LED and display device are attached in the vicinity of a seat. When an LED, for example, is used, the intensity of light, a waveform (color), emission time, the number of emissions, an emission interval (state of blinking), or the like, for example, can be used as a mode of a visual stimulus controlled by the notification unit 18.

In above-described implementations, an example has been described in which a plurality of vibration elements 103 are attached at a plurality of portions on the rear surface of the backrest of each seat so as to correspond to sitting positions in the vehicle on a one-to-one basis, and the vibration element 103 attached at the portion corresponding to the sitting position of the first occupant, who is speaking, is operated, the vibration element 103 being one of the plurality of vibration elements 103 attached to the rear surface of the backrest of the second occupant, who is a target for the speech. In this case, the vibration element 103 attached at the portion, on the seat of the second occupant, corresponding to the own seat position of the second occupant does not operate. In view of this, the vibration element 103 attached at the portion corresponding to each own seat position may be eliminated. In the example in FIG. 3A, for example, at the seat in the first row on the left side, the vibration element 103-1L at the top on the left side may be omitted. At the seat in the first row on the right side, the vibration element 103-1R at the top on the right side may be omitted. This is also true for the seats in the second row and third row on the left side and right side.

Alternatively, the vibration element 103 attached at the portion corresponding to the own seat position of the second occupant may be operated together with the vibration element 103 attached at the portion corresponding to the sitting position of the first occupant. In the example in FIG. 4B, vibration elements 103 to be operated are the vibration element 103-3R attached at the portion corresponding to the seat of the first occupant, who has made a speech, and the vibration elements 103-1L attached at the portion corresponding to the seat (own seat position) of the second occupant, who is a target for the speech. There may be a match or a difference between the mode of vibration to be applied to the vibration element 103-3R at the seat of the first occupant and the mode of vibration to be applied to the vibration element 103-1L at the seat of the second occupant.

In above-described implementations, a plurality of vibration elements 103 are attached at a plurality of portions on each seat so as to correspond to sitting positions in the vehicle on a one-to-one basis, and the vibration element 103 attached at the portion corresponding to the sitting position of the first occupant is operated. However, this is not a limitation on the present disclosure. For example, one vibration element 103 may be attached in the upper right or upper left region at the sitting position of each occupant. Then, this one vibration element 103 may be operated regardless of the sitting position of the first occupant. This vibration element 103 may be vibrated on and off a plurality of times so that the second occupant feels as if the second occupant were tapped on the shoulder. In this case, the speaker position identification unit 16 can be omitted.

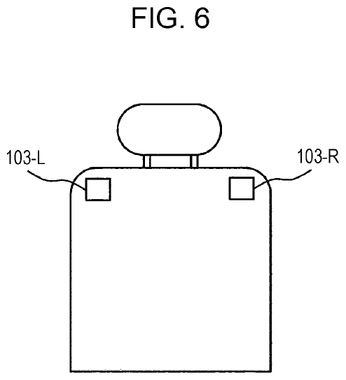

Alternatively, a plurality of vibration elements 103 may be attached at a plurality of portions so that one vibration element 103 corresponds to one row of the sitting positions of occupants. Then, one of the plurality of vibration elements 103 may be operated, the one being at the portion in the direction of the sitting position of the first occupant when viewed from the sitting position of the second occupant. In a vehicle in which seats are disposed in two rows on the left side and right side as in FIG. 2A, two vibration elements denoted 103-L and 103-R are attached in the upper right region and upper left region on the backrest of each seat as in FIG. 6. Then, a vibration element 103, which is one of the two vibration elements 103-L and 103-R attached at the sitting position of the second occupant, may be operated, the vibration element 103 being attached at the portion corresponding to the direction of the sitting position of the first occupant when viewed from the sitting position of the second occupant. Specifically, when the first occupant is sitting on any seat in the right row and the second occupant is sitting on any seat in the left row, the vibration element 103-R attached on the right side at the sitting position of the second occupant is operated. Conversely, when the first occupant is sitting on any seat in the left row and the second occupant is sitting on any seat in the right row, the vibration element 103-L attached on the left side at the sitting position of the second occupant is operated. When the first occupant and second occupant are present in the same row, both of the two vibration elements 103-L and 103-R on the left side and right side may be operated. In this example as well, the vibration element 103 may be vibrated on and off a plurality of times. This enables the second occupant to feel as if the second occupant were tapped on the shoulder in the direction in which the first occupant, who is making a speech, is present.

In above-described implementations, an example in which vibration elements 103 are attached on the rear surface of the backrest of the seat has been described. However, this is not a limitation. For example, vibration elements 103 may be attached on the front surface of the backrest or may be embedded in the backrest.

The above embodiment and implementations have been described as examples to embody the present disclosure. It should not be interpreted that the embodiment and implementations limit the technical range of the present disclosure. That is, the present disclosure can be practiced in various other forms without departing from the spirit and main features of the present disclosure.

1. An in-vehicle communication support device comprising:
a speech recognition unit configured to recognize a speech by a first occupant in a vehicle according to input information from at least one of an imaging means or a sound collecting means that are attached in the vehicle;
a target position identification unit configured to identify a sitting position of a second occupant, who is a target for the speech by the first occupant recognized by the speech recognition unit, according to input information from at least one of the imaging means or the sound collecting means; and
a notification unit configured to provide a notification to notify the second occupant at the sitting position identified by the target position identification unit that a speech has been made for the second occupant.

2. The in-vehicle communication support device according to claim 1, wherein the notification unit is configured to provide the notification by operating at least one of a tactile stimulus applying means or a visual stimulus applying means that are attached at the sitting position of the second occupant or in the vicinity of the sitting position.

3. The in-vehicle communication support device according to claim 1, wherein to identify the sitting position of the second occupant, the target position identification unit is configured to detect at least one of a line of vision of the first occupant or a face orientation of the first occupant according to the input information from at least one of the imaging means or the sound collecting means.

4. The in-vehicle communication support device according to claim 1, further comprising:
a sitting status management unit configured to store, in a storage medium, sitting status information including occupant information that identifies occupants in the vehicle and sitting position information that indicates sitting positions of the occupants in correlation to each other, and to manage the sitting status information;
wherein the target position identification unit is configured to analyze an occupant involved in the speech by the first occupant according to the input information from the sound collecting means, and to identify the sitting position of the second occupant according to a result of analysis by the target position identification unit and to the sitting status information.

5. The in-vehicle communication support device according to claim 2, further comprising:
a speech analysis unit configured to analyze at least one of a content, a volume, a pitch, or a speed of the speech by the first occupant, according to the input information from the sound collecting means;
wherein the notification unit is configured to control a mode of a tactile stimulus to be applied by the tactile stimulus applying means or of a visual stimulus to be applied by the visual stimulus applying means, according to a result of analysis by the speech analysis unit.

6. The in-vehicle communication support device according to claim 2, further comprising:
a biological analysis unit configured to analyze at least one of a facial expression, a state of eyes, a blood flow, or a behavior during the speech by the first occupant, according to the input information from the imaging means;
wherein the notification unit controls a mode of a tactile stimulus to be applied by the tactile stimulus applying means or of a visual stimulus to be applied by the visual stimulus applying means, according to a result of analysis by the biological analysis unit.

7. The in-vehicle communication support device according to claim 2, further comprising:
a speaker position identification unit configured to identify a sitting position of the first occupant the speech by whom has been identified by the speech recognition unit, according to the input information from at least one of the imaging means and the sound collecting means;
wherein at least one of a plurality of tactile stimulus applying means or a plurality of visual stimulus applying means are attached at a plurality of portions at each of sitting positions of occupants in the vehicle; and
wherein the notification unit is configured to make a control to select a portion at which to operate the tactile stimulus applying means or the visual stimulus applying means, according to the sitting position of the first occupant, the sitting position having been identified by the speaker position identification unit.

8. The in-vehicle communication support device according to claim 7, wherein:
at least one of a plurality of tactile stimulus applying means or a plurality of visual stimulus applying means are attached at a plurality of portions at each of the sitting positions of the occupants so as to correspond to the sitting positions of the occupants on a one-to-one basis; and
the notification unit is configured to make a control so as to operate the tactile stimulus applying means or the visual stimulus applying means at a portion corresponding to the sitting position of the first occupant, the sitting position having been identified by the speaker position identification unit.

9. The in-vehicle communication support device according to claim 7, wherein:
at least one of a plurality of tactile stimulus applying means or a plurality of visual stimulus applying means are attached at a plurality of portions at each of the sitting positions of the occupants so that one tactile stimulus applying means or one visual stimulus applying means corresponds to one row of the sitting positions of occupants; and
the notification unit is configured to make a control so as to operate the tactile stimulus applying means or the visual stimulus applying means at a portion in a direction of the sitting position of the first occupant when viewed from the sitting position of the second occupant, according to the sitting position of the first occupant, the sitting position having been identified by the speaker position identification unit.

10. The in-vehicle communication support device according to claim 2, wherein the notification unit is configured to control the tactile stimulus applying means or the visual stimulus applying means so as to operate on and off a plurality of times.

11. The in-vehicle communication support device according to claim 6, wherein the notification unit is configured to control the tactile stimulus applying means or the visual stimulus applying means so as to operate on and off a plurality of times.

12. The in-vehicle communication support device according to claim 1, further comprising:
a response decision unit configured to decide whether the second occupant has responded within a predetermined time after the sitting position of the second occupant was identified by the target position identification unit, according to the input information from at least one of the imaging means and the sound collecting means; and
the notification unit configured to make the notification only when the response decision unit decides that the second occupant has not responded within the predetermined time.

13. An in-vehicle communication support method comprising:
a first step in which a speech recognition unit in an in-vehicle communication support device recognizes a speech by a first occupant in a vehicle according to input information from at least one of an imaging means or a sound collecting means that are attached in the vehicle;
a second step in which a target position identification unit in the in-vehicle communication support device identifies a sitting position of a second occupant, who is a target for the speech by the first occupant recognized by the speech recognition unit, according to input information from at least one of the imaging means or the sound collecting means; and
a third step in which a notification unit in the in-vehicle communication support device notifies the second occupant at the sitting position identified by the target position identification unit that a speech has been made for the second occupant.
